(19) United States
(12) Patent Application Publication
(10) Pub. No.: US 2004/0054901 A1
(43) Pub. Date: Mar. 18, 2004

(54) Creating and verifying a sequence of consecutive data

(75) Inventors: Paul England, Bellevue, WA (US); Marcus Peinado, Bellevue, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/246,576

(22) Filed: Sep. 17, 2002

(51) Int. Cl. H04L 9/00

(52) U.S. Cl. 713/168

(57) ABSTRACT

A log is provided which can be used in an insecure environment and in which rollbacks or changes to the log may be detected. A secure data sequence is provided, and a private key is stored along with data sequence data. In one embodiment, a secure counter is used, and the secure counter value incremented and stored with each new data entry to the data sequence. The secure counter value (if used) and the new data entry are stored, signed by the private key. Also stored and signed with the new data entry is a new public key. The corresponding new private key is stored for use in signing a next data entry, and the private key that had been used to sign the data is destroyed. In this way, rollbacks and modifications to the sequence can be detected.

### FIELD OF THE INVENTION

The present invention relates to securing a sequence of data, and more specifically, to the creation and verification of a sequence of data and, in certain embodiments, to the use of a secure counter in such a way as to verify a sequence of consecutive data.

### BACKGROUND OF THE INVENTION

In a computer network such as the Internet, a server receives and process requests from other network-connected devices. The server may record these requests in a log file. The log file contains information regarding each incoming connection to the server. The log file is made up of a series of log entries. When a new item of information is recorded in the log file, a new entry is created and added to the log file. The goal of the log file is to store forensic information that will allow reconstruction of the network events that have occurred in the case of a server problem. When a server problem occurs and information is required regarding accesses to the server, the log file is examined. Problems may be of various origins, including due to a malicious attack.

A malicious attacker may use the server while performing malicious acts on the network. In order to hide information regarding the attack, the attacker may also modify the log file. The attacker may delete the log file, or may delete entries to the log file. The attacker can thereby remove information regarding the attacker's connections to the server, obscuring the attackers identity. The attacker may also try to obscure even the fact of the attack. In this case, the server may be compromised, yet there will be no way to determine that such an attack has occurred.

For example, an attack on an Internet server can be seen as proceeding in stages. In the first stage, the attacker exploits a weakness in the server, for example, a software bug, to take control of the server. This may cause entries to be made to the log file. In the second stage, the attacker, now in control of the server, executes programs of the attacker's choice on the server and otherwise uses the server. The attacker may also remove any entries from the log files that contain information related to the attack. In a possible third stage, the attacker may create a “back door” into the machine. To do this, the attacker modifies the server so as to create a way for the attacker to easily take control of the machine at the later time.

The result of such an attack is a compromised machine that cannot be identified as compromised by examination of the log files. In spite of logging, the owner of the machine does not know that an attack has taken place or that an attacker now has easy access to the machine.

One way to protect a machine against such an attack is to operate the machine with no connections to a network. Clearly, a connection to the network is beneficial for any number of communications applications, and thus this solution is undesirable. Moreover, even in the absence of a network connection, there may be other situations, in which it is desirable to create, in a non-secure environment, a log or another type of sequence of consecutive data where changes to or deletions of the consecutive data in the sequence can be detected.

Thus, there is a need for a technique to provide for the creation and verification of a sequence of consecutive data in a non-secure environment that properly addresses and satisfies heretofore unfilled needs in the art.

### SUMMARY OF THE INVENTION

In view of the foregoing, the present invention provides systems and methods for a creating and verifying a sequence of consecutive data in a non-secure environment. The invention allows any tampering with the sequence of consecutive data to be detected. In the case of a log file for a server on a network, the use of the inventive technique allows an attack to be detected. Either the attacker leaves the log file unmodified, in which case the log file will contain traces of the attack, or the attacker modifies the log file, in which case the modification is detected by use of the verification included in the inventive technique.

According to the invention, chained key pairs are used, with each key pair being used to secure one or more secure entries. According to some embodiments of the invention, a secure counter is also used in the creation and verification of the sequence of consecutive data. A secure counter is a counter that holds data (a counter value) securely, so that no adversary can change the data other than through use of the increment function. The secure counter can perform two operations on request: the secure counter can report on the counter value, and the secure counter can increment the counter value. Because operations on the counter are limited to these operations, the security of the counter is more easily ensured. If there is no way for a user or a computer system containing a secure counter to, for example, set a counter to a specific value, then an adversary will generally not be able to do so either.

According to one embodiment of the invention, the sequence of secure data is initialized by using a first key pair K₀, consisting of a public key K_{0(PUB)} and a private key K_{0(PRIV)}. A second key pair K₁, consisting of a public key K_{1(PUB)} and a private key K_{1(PRIV)}, is also used. The private key K_{0(PRIV)} is used to sign the concatenation of initial data, the current value of the secure counter, and K_{1(PUB)}. The information signed along with the signature collectively comprise the initial secure data entry, L₀. The public key K_{0(PUB)} is stored in a safe environment. The initial data may be empty. While it is not necessary to protect K_{0(PUB)} from being read by an adversary, K_{0(PUB)} should be protected from being modified by an adversary. This may be done by storing K_{0(PUB)} in off-network storage. K_{0(PRIV)} should be protected from being read by an adversary. In one embodiment of the invention, K_{0(PRIV)} is deleted. K_{1(PRIV)} is kept for use in creating the next secure data entry, L₁.

When a new data item is to be added to the sequence of data, a new secure data entry L_{N} is added to sequence of secure data entries L₀, L₁, . . . L_{N-1}. In embodiments which use a secure counter, first, the secure counter is incremented. A new key pair K_{N+1} is used. K_{N(PRIV)} is used to sign the concatenation of the new data item, the current value of the secure counter, and K_{N+1(PUB)}. The information signed, along with the signature, comprise the secure data entry L_{N}. Private key K_{N(PRIV)} should then be protected from being read by an adversary. In one embodiment of the invention, K_{N(PRIV)} is deleted. In embodiments of the invention without a secure counter, K_{N(PRIV)} is used to sign the concatenation of the new data item and K_{N+1(PUB)}.

Where the secure counter is used, in order to verify the security of the sequence of data, three tests are performed. The counter value stored in the last secure data entry L_{N} is compared to the current secure counter value to determine if they are the same. The counter value in each secure data entry Lₘ is examined to determine if that counter value is one increment of the counter value in secure data entry Lₘ₊₁. The signature on each secure data entry Lₘ is verified using K_{m(PUB)} to determine if it was signed by K_{m(PRIV)}. If each of the tests is passed, then no valid entry in the sequence of data has been changed or denied. Where no secure counter is used, only the last test is performed.

In this way, a sequence of data can be stored and the security of the sequence checked even where a possible adversary has access to the sequence after initialization.

Other features of the invention are described below.

### BRIEF DESCRIPTION OF THE DRAWINGS

The system and methods for implementing a secure sequence of consecutive data in accordance with the present invention are further described with reference to the accompanying drawings in which:

FIG. 1 is a block diagram of an exemplary computing environment in which aspects of the invention may be implemented.

FIG. 2a is a block diagram showing a sequence of secure data according to one embodiment of the invention.

FIG. 2b is a block diagram showing the components of a secure entry according to one embodiment of the invention.

FIG. 3 is a flow diagram showing the initialization of the sequence of secure data according to one embodiment of the invention.

FIG. 4 is a flow diagram showing the addition of a new data entry to the sequence of secure data according to one embodiment of the invention.

FIG. 5 is a flow diagram showing the verification of the sequence of secure data according to one embodiment of the invention.

FIG. 6 is a block diagram showing the components of a secure entry according to one embodiment of the invention.

FIG. 7 is a flow diagram showing the initialization of the sequence of secure data according to one embodiment of the invention.

FIG. 8 is a flow diagram showing the addition of a new data entry to the sequence of secure data according to one embodiment of the invention.

FIG. 9 is a flow diagram showing the verification of the sequence of secure data according to one embodiment of the invention.

### DETAILED DESCRIPTION OF THE INVENTION

Overview

A sequence of consecutive data is initialized. Additions to the sequence can then be made in an insecure environment. A verification check can be performed so that unauthorized modifications to the sequence or deletion of some data will be detected.

Initialization is performed by using an initial private key to sign the initial data and the public key from a key pair that will be used to sign the next entry in the data sequence. The addition of a new entry to a sequence of data is performed using the private key corresponding to the public key stored with the previous entry to sign the new entry and the public key from a key pair that will be used to sign the next subsequent entry. To verify the security of the sequence of data the signature on each secure data entry is verified using the public key stored in the immediately previous entry. If the test is passed, then no valid entry in the sequence of data has been changed or deleted.

In some embodiments, a secure counter is dedicated to the sequence of data. Initialization is performed by using an initial private key to sign the initial data, initial secure counter value, and the public key from a key pair that will be used to sign the next entry in the data sequence. The addition of a new entry to a sequence of data is performed by incrementing the secure counter and then using the private key corresponding to the public key stored with the previous entry to sign the new entry, the new secure counter value, and the public key from a key pair that will be used to sign the next subsequent entry.

To verify the security of the sequence of data, three tests are performed: (1) the counter value stored in the last secure data entry is compared to the current secure counter value to determine if they are the same, (2) the counter value in each secure data entry is examined to determine if that counter value is equal to the counter value in the data entry immediately previous incremented once, and (3) the signature on each secure data entry is verified using the public key stored in the immediately previous entry. If each of the tests is passed, then no valid entry in the sequence of data has been changed or deleted.

Exemplary Computing Environment

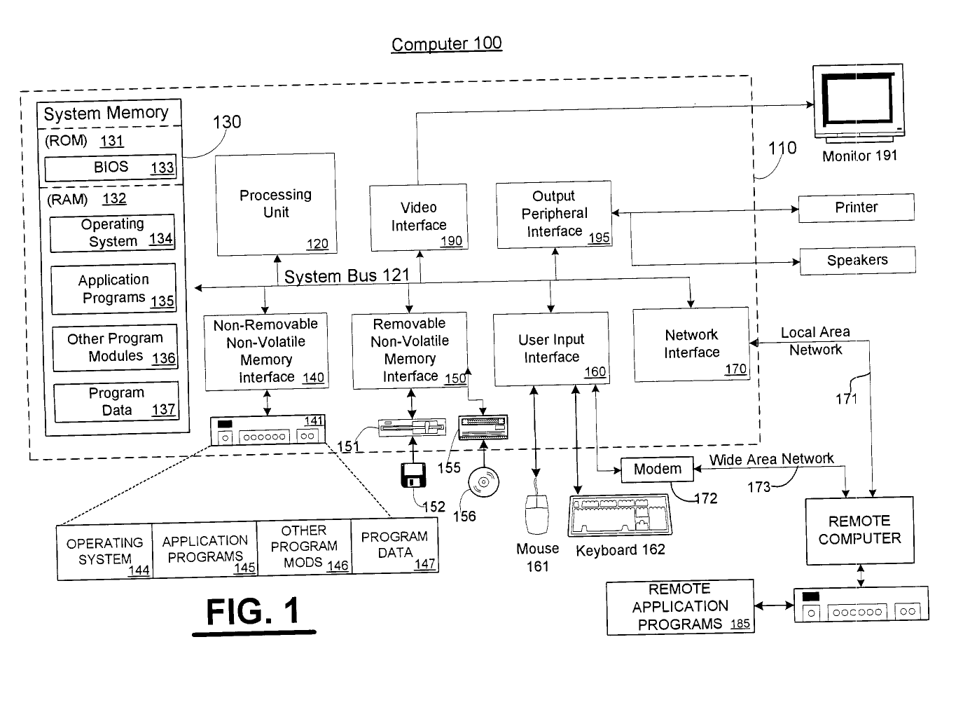

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices. Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the techniques of the present invention.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium that can be used to store the desired information and that can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Creating and Verifying a Sequence of Data

In some situations—for example, in creating a log file for a network server—a sequence of data entries is created over time. Where, as in the example of the network server, an adversary may attempt to delete or modify entries, the technique of the invention provides a way to secure the sequence of data entries so that such tampering is evident. The technique of the invention includes initializing the data sequence, adding a new data entry to an existing data sequence, and verifying that no data entries have been deleted or modified.

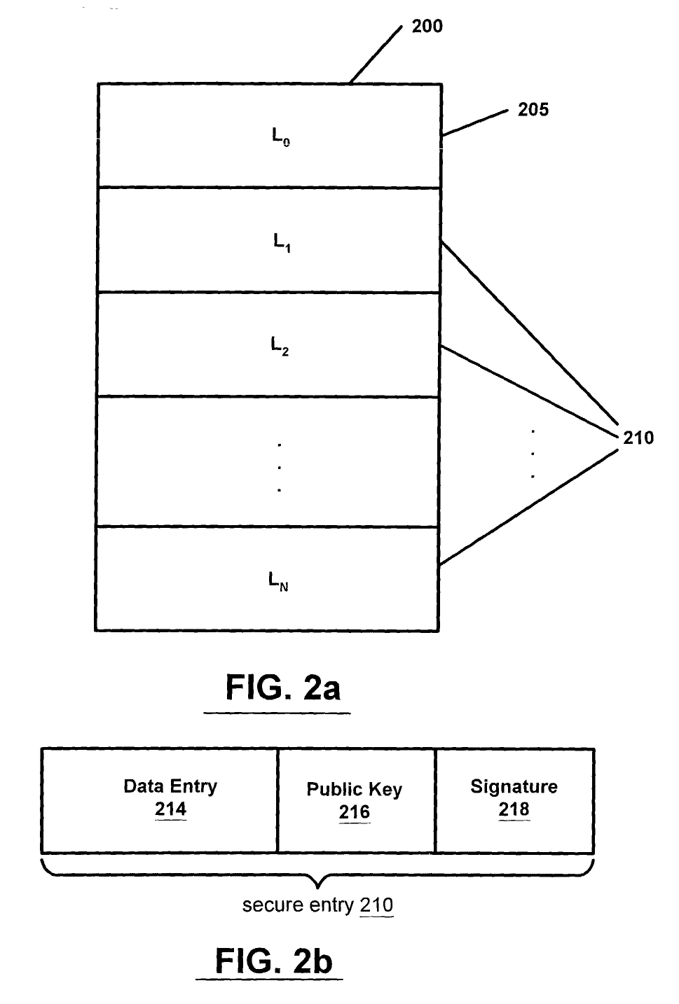

As shown in FIG. 2a, the sequence of secure data 200 consists of a number of secure entries L₀ 205 and L₁ through L_{N} 210. These secure entries can be stored in one file or in a number of files. No data structure is particularly required; however, in one embodiment, all secure entries are stored in one data file. As shown in FIG. 2b, each secure entry consists of a data entry 214, a public key 216, and a signature 218.

Initializing the Data Sequence

The initialization of the data sequence includes the use of an initial key pair (public key K_{0(PUB)} and private key K_{0(PRIV)}) and a second key pair (public key K_{1(PUB)} and K_{0(PRIV)}) for signing and verifying data. Another key pair is used each time a secure entry is added to the sequence of data. To perform the technique of the invention, any encryption method can be used that utilizes a pair of keys, a private key and a public key, where the private key is used to produce a signature for some data and the public key is used to verify that the private key was used to sign that data. In one embodiment of the invention, each time a key pair is required, a method is performed to generate a public key and a private key for use.

The invention is described with reference to an embodiment of the invention in which the signature of data is a separate data object. This signature may be a traditional digital signature. When a public key is used with this object, it can be verified that some entity in possession of the private key signed the object. However, in the present invention, a separate signature object is not required. While the invention is described with reference to a separate signature object, any verification process by which it may be verified that an entity in control of a private key had performed some operation on the data can be used. Possible processes include watermarking, in which signature data is stored within the data object signed. Possible processes also include encryption, in which the data signed must be decrypted using the public key in order for it to be readable at all.

In one embodiment of the invention, initialization is performed when the server is in a secure environment. In one embodiment, the secure environment includes protection from observation or logging of the initialization actions. In one embodiment, the initialization of the server occurs when the server is not connected to the network.

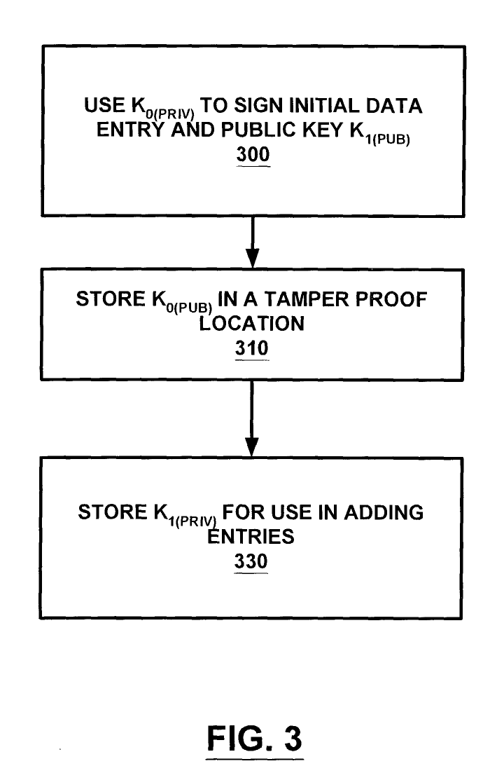

In order to initialize the sequence, as shown in FIG. 3, step 300, private key K_{0(PRIV)} is used to sign the concatenation of the initial data entry and a public key K_{1(PUB)}. This data, along with the signature, becomes the secure entry L₀ in the series of data entries. The initial data entry may be the first piece of data to be stored in the data sequence, (e.g. the first log entry); however, it may also be a placeholder, such as a blank entry or other data.

In an alternate embodiment, information in addition to the initial data entry, and the public key K_{1(PUB)} are signed and stored as part of the secure entry L₀. In another embodiment, unsigned information is also included as part of the secure entry.

In step 310, the public key K_{0(PUB)} is stored in a tamper-proof location. While, according to one embodiment, it is not necessary to protect K_{0(PUB)} from being read by an adversary, K_{0(PUB)} should still be protected from being modified by an adversary. According to one embodiment of the invention, this may be done by storing K_{0(PUB)} in off-network storage. Off-network storage includes storage on media (electronic, magnetic, or otherwise) not accessible via the network such as a floppy disk or in the memory of an off-network computer system. In step 320, K_{0(PRIV)} is protected from access by adversaries. As K_{0(PRIV)} will no longer be needed, in one embodiment of the invention, K_{0(PRIV)} is deleted. In step 330, K_{1(PRIV)} is kept to sign the next secure entry, L₁. Though FIG. 3 corresponds to an embodiment in which steps 310, 320 and 330 are performed in that order, in alternate embodiments steps 310, 320, and 330 may be done in any order, or in parallel. Once steps 310, 320, and 330 are completed, the initialization has been completed and the secure environment is no longer needed.

Adding a New Data Entry

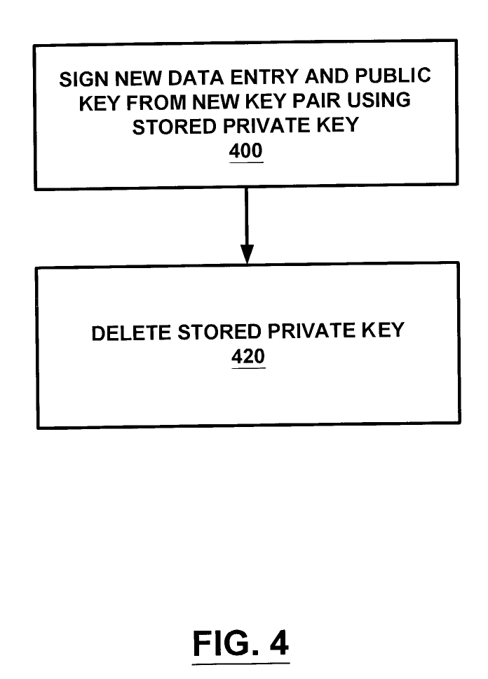

In order to add a new secure entry L_{N} to the sequence of secure entries L₀, L₁, . . . L_{N-1}, as shown in FIG. 4, step 400, the new data entry, and the public key from a new key pair K_{N+1} are signed using K_{N(PRIV)}. The information signed, along with the signature, comprise the new secure entry L_{N}. Private key K_{N(PRIV)} should then be protected from being read by an adversary. In one embodiment of the invention, as shown in step 410, K_{N(PRIV)} is deleted.

In this way, a series of entries are created with values corresponding to Table 1.

TABLE 1
Values stored in secure entries from L₀ to L_{N}

| | | Public | Private key used |
|---|---|---|---|
| Secure | Data | key | to sign data entry, |
| entry | entry | stored | and public key |
| L₀ | initial data entry | K_{1(PUB)} | K_{0(PRIV)} |
| L₁ | second data entry | K_{2(PUB)} | K_{1(PRIV)} |
| L₂ | third data entry | K_{3(PUB)} | K_{2(PRIV)} |
| . . . | . . . | . . . | . . . |
| L_{N} | Nth data entry | K_{N(PUB)} | K_{N+1(PRIV)} |

In an alternate embodiment, information in addition to the initial data entry and the public key K_{N+1(PUB)} are signed and stored as part of the secure entry L_{N}. For example, secure entries L₀ through L_{N-1} may be signed and stored as part of the secure entry. Partial information about secure entries L₀ through L_{N-1}, such as hash values or check sums, may also be signed and stored as part of the secure entry. In an alternate embodiment, when a new secure entry is added, information about some subset of the secure entries previous to that new secure entry is included in the information signed and included as part of the new secure entry.

In another embodiment, unsigned information is also included as part of the secure entry.

Verifying Data Entries

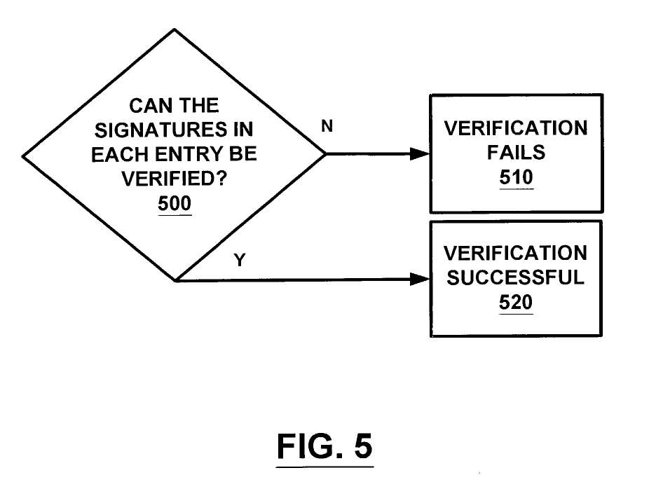

To verify that the data entries have not been modified or tampered with, as shown in FIG. 5, step 500, the signature on each secure entry Lₘ is checked using K_{m(PUB)} to determine if it was signed by K_{m(PRIV)}. This will require the use of K_{0(PUB)}, which is stored in a tamper-proof location, as previously described. In addition, this requires the use of K_{1(PUB)} through K_{m(PUB)}, which are stored in secure entries L₀ through Lₘ₋₁. If this verification is successful, then all of the secure entries have been verified and the verification of the sequence of secure data is successful 520. If this test is failed, the verification fails, 510.

In this way, even where a possible adversary has access to the sequence after initialization, the sequence of data can be verified.

Creating and Verifying a Sequence of Data When Using a Secure Counter

According to one embodiment of the invention, a secure counter is used. A secure counter is a counter that holds data (a counter value) securely, so that no adversary can change the data other than by incrementing the counter, and which can perform two operations on request. The secure counter can report on the counter value, and the secure counter can increment the counter value according to a predetermined increment technique. Because operations on the counter are limited to these operations, the security of the counter is more easily ensured. If there is no way for a user or a computer system containing a secure counter to, for example, set a counter to a specific value, then an adversary will generally not be able to do so either. In one embodiment, the counter increment is addition of one to the previous counter value. In other embodiments, the increment may be addition of a different value, subtraction, or other mathematical operations.

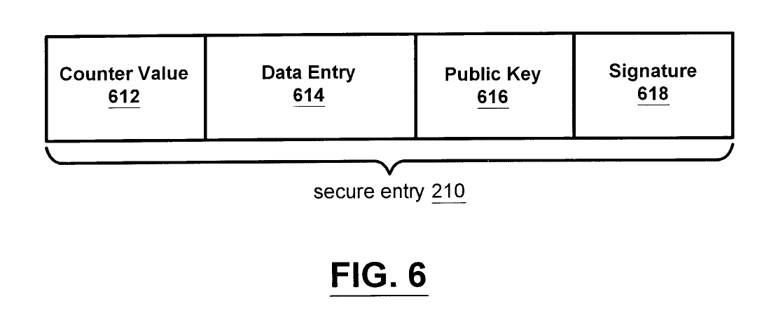

Again, as shown in FIG. 2a, the sequence of secure data 200 consists of a number of secure entries L₀ 205 and L₁ through L_{N} 210. These secure entries can be stored in one file or in a number of files. No data structure is particularly required; however, in one embodiment, all secure entries are stored in one data file. As shown in FIG. 6, each secure entry 210 consists of a counter value 612, a data entry 614, a public key 616, and a signature 618, as does secure entry 205.

Initializing the Data Sequence When a Secure Counter is Used

Again, the initialization of the data sequence includes the use of an initial key pair (public key K_{0(PUB)} and private key K_{0(PRIV)}) and a second key pair (public key K_{1(PUB)} and K_{1(PRIV)}) for signing and verifying data. Another key pair is used each time a secure entry is added to the sequence of data.

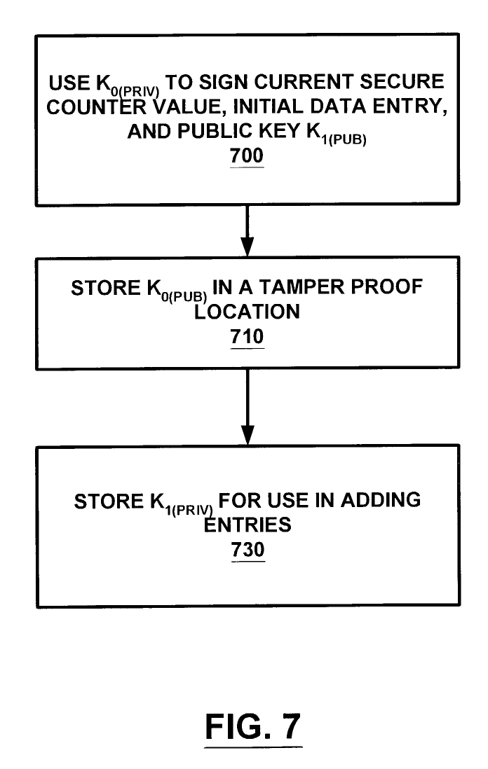

In order to initialize the sequence, as shown in FIG. 7, step 700, private key K_{0(PRIV)} is used to sign the concatenation of the current secure counter value, the initial data entry, and a public key K_{1(PUB)}. This data, along with the signature, becomes the secure entry L₀ in the series of data entries. The initial data entry may be the first piece of data to be stored in the data sequence, (e.g. the first log entry); however, it may also be a placeholder, such as a blank entry or other data.

In an alternate embodiment, information in addition to the current secure counter value, the initial data entry, and the public key K_{1(PUB)} are signed and stored as part of the secure entry L₀. In another embodiment, unsigned information is also included as part of the secure entry.

In step 710, the public key K_{0(PUB)} is stored in a tamper-proof location. While, according to one embodiment, it is not necessary to protect K_{0(PUB)} from being read by an adversary, K_{0(PUB)} should still be protected from being modified by an adversary. According to one embodiment of the invention, this may be done by storing K_{0(PUB)} in off-network storage. Off-network storage includes storage on media (electronic, magnetic, or otherwise) not accessible via the network such as a floppy disk or in the memory of an off-network computer system. In step 720, K_{0(PRIV)} is protected from access by adversaries. As K_{0(PRIV)} will no longer be needed, in one embodiment of the invention, K_{0(PRIV)} is deleted. In step 730, K_{1(PRIV)} is kept to sign the next secure entry, L₁. Though FIG. 7 corresponds to an embodiment in which steps 710, 720 and 730 are performed in that order, in alternate embodiments steps 710, 720, and 730 may be done in any order, or in parallel. Once steps 710, 720, and 730 are completed, the initialization has been completed and the secure environment is no longer needed.

Adding a New Data Entry When a Secure Counter is Used

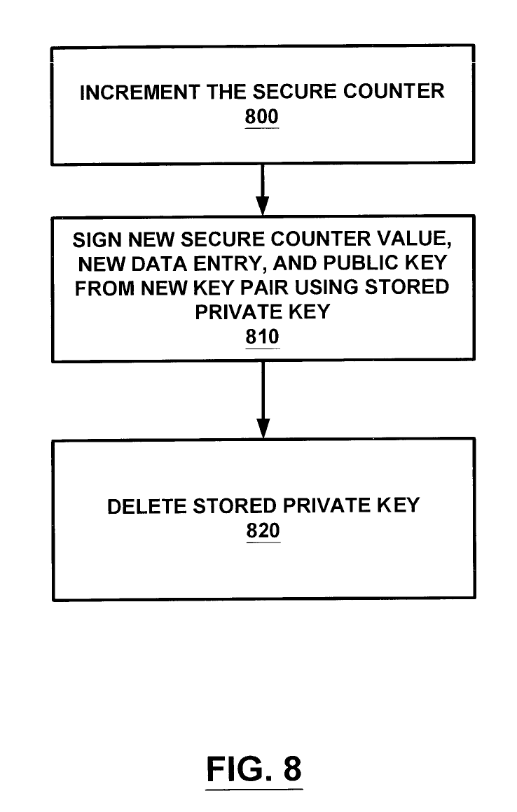

In order to add a new secure entry L_{N} to the sequence of secure entries L₀, L₁, . . . L_{N-1}, as shown in FIG. 8, step 800, the secure counter is incremented. In step 810, the new secure counter value, the new data entry, and the public key from a new key pair K_{N+1} are signed using K_{N(PRIV)}. The information signed, along with the signature, comprise the new secure entry L_{N}. Private key K_{N(PRIV)} should then be protected from being read by an adversary. In one embodiment of the invention, as shown in step 820, K_{N(PRIV)} is deleted.

In this way, a series of entries are created with values corresponding to Table 2.

TABLE 2
Values stored in secure entries from L₀ to L_{N}

| | | | Public | Private key used to |
|---|---|---|---|---|
| Secure | Counter | | key | sign counter value, data |
| entry | value stored | Data entry | stored | entry, and public key |
| L₀ | initial counter | initial data | K_{1(PUB)} | K_{0(PRIV)} |
| | value C | entry | | |
| L₁ | C incremented | second | K_{2(PUB)} | K_{1(PRIV)} |
| | once | data entry | | |
| L₂ | C incremented | third | K_{3(PUB)} | K_{2(PRIV)} |
| | twice | data entry | | |
| . . . | . . . | . . . | . . . | . . . |
| L_{N} | C incremented | Nth data | K_{N(PUB)} | K_{N+1(PRIV)} |
| | N times | entry | | |

In an alternate embodiment, information in addition to the current secure counter value, the initial data entry, and the public key K_{N+1(PUB)} are signed and stored as part of the secure entry L_{N}. For example, secure entries L₀ through L_{N-1} may be signed and stored as part of the secure entry. Partial information about secure entries L₀ through L_{N-1}, such as hash values or check sums, may also be signed and stored as part of the secure entry. In an alternate embodiment, when a new secure entry is added, information about some subset of the secure entries previous to that new secure entry is included in the information signed and included as part of the new secure entry.

In another embodiment, unsigned information is also included as part of the secure entry.

Verifying Data Entries When a Secure Counter is Used

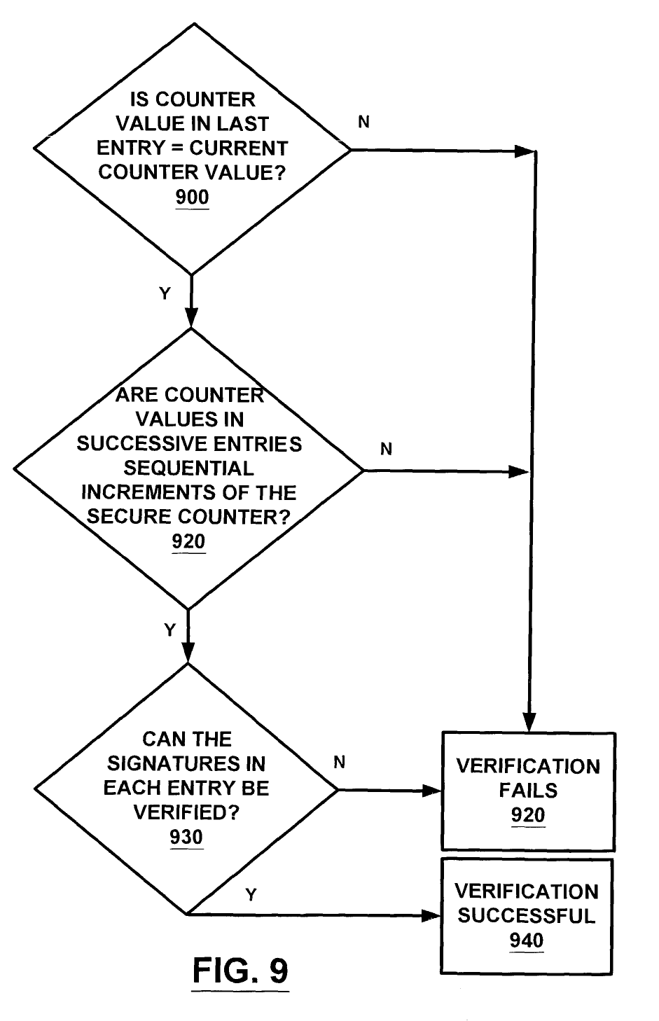

To verify that the data entries have not been modified or tampered with, three tests are performed. First, as shown in FIG. 9, step 900, the counter value stored in the last secure entry L_{N} is compared to the current secure counter value to determine if they are the same. If the counter value stored in the last secure entry L_{N} is not equal to the current secure counter value, then a rollback may have occurred. Some data entries may have been erased. If the test is not passed, then the verification fails, step 910. If the test is passed, the next test 920 is performed.

This next test, step 920, is to determine whether the counter values stored in secure entries L₁ to L_{N} are consecutive increments of the counter. Every counter value stored in a secure entry Lₘ₊₁, should be one increment greater than that stored in secure entry Lₘ. If this is not true, then some entries may have been deleted and the verification fails, 910. If the test is passed, the next test, 930, is performed.

The last test, step 930, is verifying the signature on each secure entry Lₘ using K_{m(PUB)} to determine if it was signed by K_{m(PRIV)}. This will require the use of K_{0(PUB)} , which is stored in a tamper-proof location, as previously described. In addition, this requires the use of K_{1(PUB)} through K_{m(PUB)}, which are stored in secure entries L₀ through Lₘ₋₁. If all verifications are successful, then all of the secure entries have been verified and the verification of the sequence of secure data is successful. If this test is failed, the verification fails, 920.

In this way, even where a possible adversary has access to the sequence after initialization, the sequence of data can be verified. Using only the second two tests, which verify that the counter values are consecutive and verify the signatures, would verify that all entries are sequential and genuine. However, a rollback, in which one or more entries at the end of the sequence are deleted, would not be detected. In a preferred embodiment, the three tests described are included; however, alternate embodiments may use only one or two of the tests. For example, one embodiment uses only the counter increment check (step 520) and signature verification (step 530).

Conclusion

Herein a system and method for a secure sequence of data entries. As mentioned above, while exemplary embodiments of the present invention have been described in connection with various computing devices and network architectures, the underlying concepts may be applied to any computing device or system in which it is desirable to use a secure sequence of data entries. Thus, the techniques for implementing a secure sequence of data entries in accordance with the present invention may be applied to a variety of applications and devices. For instance, the techniques of the invention may be applied to the operating system of a computing device, provided as a separate object on the device, as part of another object, as a downloadable object from a server, as a “middle man” between a device or object and the network, as a distributed object, etc. While exemplary names and examples are chosen herein as representative of various choices, these names and examples are not intended to be limiting.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the techniques of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method of initializing a secure sequence of data where a first key pair comprises a first public key and a first private key, and where a second key pair comprises a second public key and a second private key, comprising:
protecting the integrity of a concatenation comprising an initial data entry and said second public key using said first private key;
storing said first public key so as to prevent unauthorized modification;
protecting said first private key from unauthorized access; and
storing said second private key for later use.

2. The method of claim 1, where said protecting step comprises signing a concatenation comprising said secure counter value, an initial data entry, and said second public key using said first private key.

3. The method of claim 2, where said signing step produces a signature object, and where said method further comprises:
storing said concatenation and said signature object.

4. The method of claim 1, where said protecting step produces a watermarked object, and where said method further comprises:
storing said watermarked object.

5. The method of claim 1, where said protecting step produces an encrypted object, and where said method further comprises:
storing said encrypted object.

6. The method of claim 1, where said initialization is performed in a secure environment.

7. The method of claim 1, where said initialization occurs in a computer system comprising a connection operable to connect said computer system to a network and where said initialization occurs when said computer system is not connected to said network.

8. The method of claim 1, where said step of protecting said first private key from unauthorized access comprises destroying said first private key.

9. The method of claim 1, where a secure counter stores a secure counter value, and where said concatenation further comprises said secure counter value.

10. A method of adding a new entry to a secure sequence of data where a new entry key pair comprises a new entry public key and a new entry private key, comprising:
protecting the integrity of a concatenation comprising said new entry and said new entry public key using said stored private key; and
storing said new entry private key for later use.

11. The method of claim 10, where said protecting step comprises signing said concatenation comprising said new entry and said new entry public key using said stored private key.

12. The method of claim 10, where said protecting step produces a signature object, and where said method further comprises:
storing said concatenation and said signature object.

13. The method of claim 10, where said protecting step produces a watermarked object, and where said method further comprises:
storing said watermarked object.

14. The method of claim 10, where said protecting step produces an encrypted object, and where said method further comprises:
storing said encrypted object.

15. The method of claim 10, where said method of adding a new entry further comprises:
protecting said stored private key from unauthorized access.

16. The method of claim 15, where said step of protecting said stored private key from unauthorized access comprises destroying said stored private key.

17. The method of claim 10, where a secure counter stores a secure counter value and increments said secure counter value to a new secure counter value upon an increment request, where said method further comprises the step of requesting an increment of said secure counter to a new secure counter value, and where said concatenation further comprises said new secure counter value.

18. A method of verifying a secure sequence of data stored as a sequence of secure entries, each secure entry comprising a data entry, a public key, and verification information comprising:
for each of said secure entries, verifying said verification information.

19. The method of claim 18, where said verification information comprises a signature object, and where said verifying of said verification information comprises:
verifying said signature object.

20. The method of claim 18, where said verification information comprises a watermarked object, and where said verifying of said verification information further comprises:
verifying a watermark of said watermarked object.

21. The method of claim 18, where verification information produces an encrypted object, and where said verification of said verification information further comprises:
unencrypting said encrypted object.

22. The method of claim 18, where said method further comprises:
returning an indication of success or failure of said verification.

23. The method of claim 18, where a secure counter stores a secure counter value and increments said secure counter value to a new secure counter value according to an increment method upon an increment request, where each secure entry further comprises a counter value, and where said method further comprises:
verifying that, for all pairs of two consecutive secure entries of a first secure entry followed immediately by a second secure entry, the counter value for said second secure entry is equal to the counter value for said first secure entry incremented according to said increment method; and

24. The method of claim 23, where said method of verifying further comprises:
verifying that said secure counter value corresponds to said counter value for the last of said sequence of secure entries.

25. A method of storing a secure sequence of data where a first key pair comprises a first public key and a first private key, and where a second key pair comprises a second public key and a second private key, comprising:
initializing said secure sequence of data by performing steps comprising: signing a concatenation comprising an initial data entry, and said second public key using said first private key; storing said first public key so as to prevent unauthorized modification; protecting said first private key from unauthorized access; and storing said second private key for later use;
adding a new entry to said secure sequence of data by performing steps comprising: signing a concatenation comprising said new entry and a new entry public key using a previously stored private key; and storing a new entry private key corresponding to said new entry public key for later use;
verifying said secure sequence of data by performing steps comprising: for each of said secure entries, verifying verification information for said secure entry.

26. The method of claim 25, where said initialization step occurs in a computer system comprising a connection operable to connect said computer system to a network and where said initialization occurs when said computer system is not connected to said network.

27. The method of claim 25, where said step of protecting said first private key from unauthorized access comprises destroying said first private key.

28. The method of claim 25, where said step of adding a new entry further comprises:
protecting said stored private key from unauthorized access.

29. The method of claim 28, where said step of protecting said stored private key from unauthorized access comprises destroying said stored private key.

30. The method of claim 25, where a first public key has been stored and where said step of, for each of said secure entries, verifying said signature comprises:
verifying said verification information for the first secure entry of said sequence of secure entries using said first public key;
verifying said verification information for each other secure entry of said sequence of secure entries by verifying the verification information for said entry using the public key stored in the entry immediately previous to said entry in said sequence of secure entries.

31. The method of claim 25, where a secure counter stores a secure counter value according to an increment method upon an increment request, where said step of initializing said secure sequence of data comprises signing a concatenation comprising said secure counter value, an initial data entry, and said second public key using said first private key; where said step of adding a new entry to said secure sequence of data comprises requesting an increment of said secure counter to a new secure counter value and signing a concatenation comprising said new secure counter value, said new entry, and a new entry public key using a previously stored private key; and where said step of verifying said secure sequence of data further comprises verifying that for all pairs of two consecutive secure entries of a first secure entry followed immediately by a second secure entry, a counter value for said second secure entry is equal to a counter value for said first secure entry incremented according to said increment method.

32. The method of claim 25, where said step of verifying further comprises:
verifying that said secure counter value corresponds to said counter value for the last of said sequence of secure entries.

33. The method of claim 25, where said verification information comprises a signature object.

34. The method of claim 25, where said verification information comprises a watermarked object.

35. The method of claim 25, where verification information comprises an encrypted object.

36. The method of claim 25, where said step of verifying said secure sequence of data further comprises:
returning an indication of success or failure of said verification.

37. A data structure for storing a sequence of secure data, said data structure comprising:
a data entry, a stored public key for use in verifying the next data entry in said sequence of secure data, and verification information verifying the security of said data entry.

38. The data structure of claim 37, said data structure further comprising a counter value for establishing a sequence of secure data.

39. A sequence of secure data stored in ordered data elements, where each data element comprises a data entry, a stored public key, and verification information, and where, for each consecutive pairs of data elements comprising a first data element and a second data element sequentially following said first data element, said stored public key in said first data element can be used to verify said signature information in said second data element.

40. The sequence of claim 39, where each of said data element further comprises a counter value.

41. A system for initializing a secure sequence of data comprising:
means for using a first private key associated with a first public key to sign a concatenation comprising an initial data entry and a second public key;
means for storing said first public key;
means for protecting said first private key from unauthorized access; and
means for storing a second private key associated with said second public key.

42. The system of claim 41, where said means for protecting said first private key comprises means for deleting said first private key.

43. The system of claim 41, where said system further comprises means for storing a counter value, and where said concatenation further comprises said counter value.

44. A system for adding a new data entry to a secure sequence of data stored as a sequence of secure entries where a stored private key corresponds to a public key stored in the last secure entry of said sequence of secure entries, comprising:
means for using said stored private key to sign a concatenation comprising said new data entry and a new entry public key corresponding to a new entry private key; and
means for storing said new entry private key.

45. The system of claim 44, further comprising:
means for destroying said stored private key.

46. The system of claim 44 further comprising means for storing a secure counter value and incrementing said secure counter value upon an increment request and means for requesting an increment of said secure counter value to a new secure counter value, and where said concatenation further comprises said new secure counter value.

47. A system for verifying a secure sequence of data stored as a sequence of secure entries, where each secure entry comprises a data entry, a public key, and verification information, comprising:
means for verifying said verification information for each of said secure entries.

48. The system of claim 47, where said system further comprises means for storing a first public key, and where said means for verifying information for each of said secure entries comprises:
means for verifying said verification information in the first secure entry of said sequence of secure entries using said first public key; and
means for verifying said verification information, for each secure entry from among all but said first secure entry of said sequence of secure entries, using said public key stored in said secure entry immediately before said secure entry for which said verification information is being verified.

49. The system of claim 47, where each secure entry further comprises a secure counter value, where a secure counter stores a secure counter value and increments said secure counter value to a new secure counter value according to an increment method upon an increment request, said system further comprising:
means for verifying that, for all pairs of two consecutive secure entries of a first secure entry followed immediately in said sequence of secure entries by a second secure entry, said counter value stored in said second secure entry is equal to said counter value stored in said first secure entry incremented according to said increment method; and

50. The system of claim 49, further comprising:
means for verifying that said counter value stored in the last of said sequence of secure entries corresponds to said secure counter value.

51. A computer-readable medium for initializing a secure sequence of data, said medium with instructions to perform acts comprising:
using a first private key associated with a first public key to sign a concatenation comprising an initial data entry and a second public key;
storing said first public key;
protecting said first private key from unauthorized access; and
storing a second private key associated with said second public key.

52. The computer-readable medium of claim 51, where said act of protecting said first private key comprises deleting said first private key.

53. The computer-readable medium of claim 51, said acts further comprising:
storing a secure counter value.

54. A computer-readable medium for adding a new data entry to a secure sequence of data stored as a sequence of secure entries where a stored private key corresponds to a public key stored in the last secure entry of said sequence of secure entries, said medium with instructions to perform acts comprising:
using said stored private key to sign a concatenation comprising said new data entry and a new entry public key corresponding to a new entry private key; and
storing said new entry private key.

55. The computer-readable medium of claim 54, said medium with instructions to perform acts further comprising:
destroying said stored private key.

56. The computer-readable medium of claim 54, said medium with instructions to perform acts further comprising:
storing a secure counter value and incrementing said secure counter value to a new secure counter value upon an increment request.

57. A computer-readable medium for verifying a secure sequence of data stored as a sequence of secure entries, where each secure entry comprises a data entry, a public key, and verification information, said medium with instructions to perform acts comprising:
verifying information for each of said secure entries.

58. The computer-readable medium of claim 57, where said instructions further comprise instructions to perform the act of storing a first public key, and where said act of verifying information for each of said secure entries comprises:
verifying said verification information in the first secure entry of said sequence of secure entries using said first public key; and
verifying said verification information, for each secure entry from among all but said first secure entry of said sequence of secure entries, using said public key stored in said secure entry immediately before said secure entry for which said verification information is being verified.

59. The computer-readable medium of claim 57, where a secure counter stores a secure counter value and increments said secure counter value to a new secure counter value according to an increment method upon an increment request, where each secure entry further comprises a counter value, further comprising:
verifying that, for all pairs of two consecutive secure entries of a first secure entry followed immediately in said sequence of secure entries by a second secure entry, said counter value stored in said second secure entry is equal to said counter value stored in said first secure entry incremented according to said increment method.

60. The computer-readable medium of claim 59, said medium with instructions to perform acts further comprising:
verifying that said counter value stored in the last of said sequence of secure entries corresponds to said secure counter value.
